(19) United States
(12) Patent Application Publication
(10) Pub. No.: US 2025/0271406 A1
(43) Pub. Date: Aug. 28, 2025

(54) AUTOMATED RETENTION INDEX CALIBRATION

(71) Applicant: CERNO BIOSCIENCE LLC, Las Vegas, NV (US)

(72) Inventors: Don Kuehl, Windham, NH (US); Stacey Simonoff, Portsmouth, NH (US); Yongdong Wang, Las Vegas, NV (US)

(73) Assignee: CERNO BIOSCIENCE LLC, Las Vegas, NV (US)

(21) Appl. No.: 19/061,257

(22) Filed: Feb. 24, 2025

Related U.S. Application Data
(60) Provisional application No. 63/557,341, filed on Feb. 23, 2024.

(51) Int. Cl. G01N 30/86; G01N 30/72

(52) U.S. Cl. CPC G01N 30/8679; G01N 30/72; G01N 30/8668; G01N 30/8693

(57) ABSTRACT

A method, spectral detection system and computer readable medium for acquiring spectral data for a sample containing at least two standard compounds of known retention indices; using the spectral data to select relevant retention time windows corresponding to the at least two standard compounds of known retention indices; building an initial retention index calibration model using the at least two standard compounds of known retention indices; and refining the initial retention index calibration model by one of adding additional or removing existing standard compounds of known retention indices from the calibration model. The calibration model is then used to predict the retention index of an unknown compound from its measured retention time. Both the predicted retention index and the spectral library search are utilized together to indicate the likelihood of a positive compound identification with higher confidence.

### CROSS REFERENCE TO RELATED APPLICATIONS

Reference is made to U.S. Pat. Nos. 6,983,213, 7,493,225 and 7,577,538; U.S. Pat. No. 7,781,729; U.S. provisional patent application Ser. No. 62/632,414, filed on Feb. 19, 2018 and as International Patent Application PCT/US2019/018568 published as WO2019161382; U.S. provisional patent application Ser. No. 62/830,832, filed on Apr. 8, 2019 and as U.S. patent application Ser. No. 16/843,505 published as US 2020-0232956 A1; and U.S. provisional patent application Ser. No. 63/305,969, filed on Feb. 2, 2022 and as International Patent Application PCT/US2023/012187 published as WO 2023/150208. The entire teachings of these patent documents are hereby incorporated herein by reference, in their entireties, for all purposes.

This application claims the benefit of provisional application Ser. No. 63/557,341, filed on Feb. 23, 2024, which is also hereby incorporated herein by reference, in its entirety, for all purposes.

### BACKGROUND OF THE DISCLOSURE

### 1. Field of the Disclosure

The present disclosure relates to the field of chromatographic or other separation connected with a spectral detection system such as gas chromatography (GC) with Mass Spectrometry (MS) detection and, more particularly, to methods for acquiring, processing, and analyzing the resulting separation and spectral data.

### 2. Description of the Related Art

It has become clear that the most significant advance in GC/MS unknown identification is the availability and use of Retention Index (RI) from the NIST libraries. The combination of accurate experimental RI value coverage and slightly less accurate AI (Artificial Intelligence) modeling of the remaining compounds means nearly 100% of the compounds in the library are assigned quality RI values. This enables highly confident identification of unknowns (and improved confirmation of target or known compounds), far superior to just MS spectral library search alone, which oftentimes give ambiguously good or poor matches.

To take advantage of the library RI values, however, one must calibrate the GC retention time into retention index on a regular basis, either daily or perhaps every few days or weeks. The typical calibration involves a separate GC run of the n-alkane series of standards to create the RI calibration. These n-alkanes are typically used because the standards are readily available and they themselves are the standard compounds from which RI is defined. For example, n-hexane (C6H14) has a defined RI of 600 regardless of the chromatography column type, n-heptane (C7H16) has a defined RI of 700, etc. Alkane standards are also readily available commercially and are relatively inexpensive, and an n-alkane series (also called a “ladder”) elute cleanly and sharply from the chromatography column at regularly spaced retention times (RT) to provide an excellent calibration curve (FIG. 1). While compounds other than n-alkanes can be used for RI calibration, they are less commonly used since 1) one needs to carefully choose a series of compounds with even RT spacing 2) these compounds may not provide sharp GC peaks to provide the most accurate RT values, and 3) the library RI values typically contain experimental or computational errors giving a less accurate RI calibration. Nonetheless, there may be more practical reasons to use other RI standards instead of n-alkanes. For example, some sample mixtures are used for instrument validation or for quantitative references. In this case, using mixtures other than alkanes may make the workflow more efficient by not having to run or inject a separate n-alkane calibration. There are also applications where the test sample itself without any added standards contains enough compounds at high enough concentrations with sufficient separations to yield high library search results, enabling a self-RI calibration by using these compounds as the RI standards, as disclosed in the cross-referenced application (U.S. provisional patent application Ser. No. 63/305,969, filed on Feb. 2, 2022 and as International Patent Application PCT/US2023/012187 published as WO2023/150208).

While n-alkanes make for an excellent RI calibration standard for GC, there are some serious real world usability limitations that have not been addressed. The most significant problem is that other peaks in the run can make it difficult to automatically locate and correctly identify each n-alkane in the series. For example, some sampling techniques, such a solid phase microextraction (SPME) or large volume Injections (LVI) typically contain very significant background peaks which can make the proper assignment of the n-alkane peaks used for the calibration complex, time consuming, or otherwise error-prone. Also, peaks introduced due to carryover from previous injections often make creating relatively clean RI calibrations difficult. Other complications include impurities in the standards themselves or in the solvents used in the sample preparation and injection process. These additional spurious peaks can make the automatic identification of the desired n-alkane standards peaks either difficult or subject to errors or both. We refer to these additional peaks more generally as “interfering peaks”.

In addition, many n-alkane standard series are not necessarily designed as a continuous (non-interrupting) ladder (n, n+1, n+2 . . . ) and sometimes some n-alkanes are skipped in the standard; especially heavier alkanes which tend to “bunch up” in retention time and hence the inclusion of a continuous ladder is not necessary. Anther problem is that the coelution of n-alkanes with interfering peaks can further complicate the identification of the n-alkane standard peak. Finally, if the n-alkane series is added into a sample as an internal standard, having a smaller number of non-continuous n-alkanes will reduce potential co-elution with sample peaks. These issues also complicate the automatic identification of the n-alkanes which can lead to improper or outright erroneous RI calibration of the GC.

One possible way to automatically identify the calibration compound peaks is by simply selecting the N largest peaks in the run, where N is the total number of n-alkanes expected in the calibration standard, and to assume they are the desired calibration compounds. Unfortunately, in practice, it is not uncommon for the previously discussed background or contaminants peaks to be present with higher signals than the calibration compounds. This is especially true due to the fact that the peaks of the later eluting heavier (higher molecular weight) standards can be broader and less intense than earlier eluting peaks, making them even more susceptible to background interferences. Exacerbating the problem of less intense peaks at the greater retention times is that the background interference, typically from column bleed, can mask the identification of the smaller, heavier n-alkanes peaks, as shown in FIG. 2. To avoid the problem, it is possible for the user to manually define retention time windows for each calibration compound to avoid mistakenly selecting these interfering peaks, but this can be a tedious, error prone, and time-consuming process which has to be continually updated as the chromatography or column conditions and physical state change (e.g. column length change due to “trimming” columns).

If a mass spectrometer (MS) is used as the GC detector, it is possible to use MS spectral library search techniques to help identify or confirm the desired standard peaks. Unfortunately, as the n-alkanes molecular weights increase (e.g. particularly above a carbon count of C15-20), conventional search algorithms cannot uniquely identify and differentiate between the n-alkanes. The reason for this is that the MS electron impact (EI) fragmentation patterns on n-alkanes all contain the exact same fragments up to the molecular ion m/z ratio of the standard, as n-alkanes are a simple linear carbon chain where the characteristic cleaving of the molecule occurs between the carbon bonds. As the molecular weight increases, statistically, the intensity of the heavier fragments is drastically reduced to the point that they contribute a proportionally insignificant unique fragment fingerprint for the compound. In fact, with some of the heaviest n-alkanes, the desired alkane standard sometimes do not even show up among the top best spectral search matches, as in FIG. 3. As the MS spectrum of these heavy alkanes become indistinguishable from each other, the correct assignment of standard GC peaks becomes either difficult or even impossible, a practical issue neither discussed nor addressed in the prior art.

Accordingly, it would be desirable and highly advantageous to have methods to overcome the above-described deficiencies and disadvantages of the prior art.

### SUMMARY OF THE DISCLOSURE

In general, the present disclosure is directed to the following improvements:

1. A new approach to accurately and automatically locate expected RI calibration standard peaks, saving time and effort while avoiding both computer or human errors.

2. A new approach to anticipate and predict possible RT time window where an expected RI standard is located.

3. A new approach to determine the correct standard compounds in a mixture such as n-alkane series automatically for them to be used as RI calibration standards, even when spectral library match is ambiguous or incorrect.

4. A new and robust approach to create RI calibration automatically from either a standard mixture or a test sample itself without human intervention.

Each of these aspects will be described below along with experimental results to demonstrate their utilities.

### BRIEF DESCRIPTION OF THE DRAWINGS

FIG. 1 is an example of a “clean” alkane calibration containing n-alkanes C7-C39. The absence of any significant background or contaminant peaks making the identification of each compound in the series a simple problem is noted.

FIG. 2 is an example of an n-alkane calibration which contains contaminant peaks carried over from SPME. Identification of the alkane peaks by intensity would not be possible. In addition, search identification of the n-alkanes greater than C16 fails to find the correct match due to the high background and low signal-to-noise.

FIG. 3 is a list of top MS spectral library matches for a “clean” n-alkane calibration run (FIG. 1) for peak at 17.73 minutes (n-alkane name: n-Docosane, formula: C22H46), which is not correctly identified at all in the top 20 matches. The two best matches are for the n-alkanes. Hence when the wrong n-alkane is identified, it is usually identified in the correct chemical class of n-alkanes. Even if some matches are not an n-alkane, they are all identified as saturated hydrocarbon, i.e., compounds with the correct type of formula C(n)H(2n+2).

FIG. 4 is a block diagram of a mass spectrometer system coupled to a separation device that can utilize the methods disclosed herein.

FIG. 5 depicts a temperature program ramp starting at 40° C. and going to 150° C. as shown overlaid on the elution profile, with the major peaks corresponding to C5-C12.

FIG. 6 depicts the same n-alkane standard as in FIG. 5 but under a different temperature program (as overlaid) which causes the retention times and relative spacings to be quite different.

FIG. 7 includes a flow chart of one embodiment disclosed herein.

A component or a feature that is common to more than one drawing is indicated with the same reference number in each of the drawings.

### DESCRIPTION OF THE EMBODIMENTS

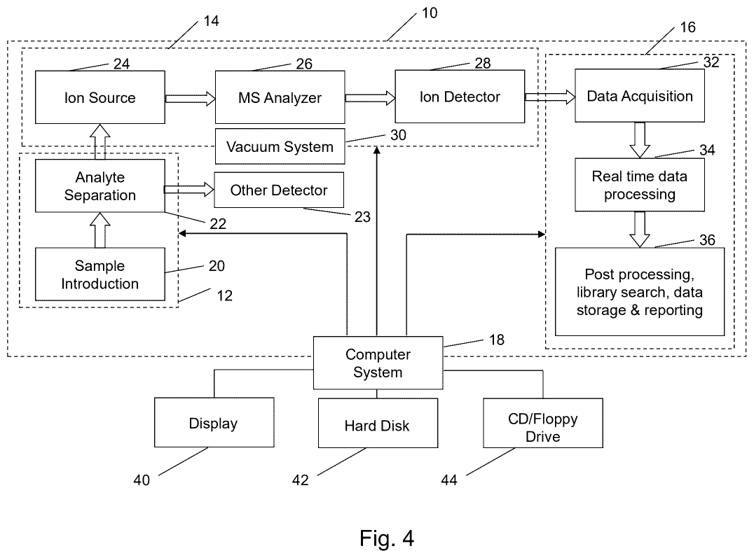

Referring to FIG. 4, there is shown a block diagram of an analysis system 10, that may be used to analyze volatile organic compounds or other molecules, as noted above, incorporating features of the present disclosure. Although the present disclosure is directed to the single embodiment shown in the drawings, it is understood that the present disclosure can be embodied in many alternate forms or embodiments. In addition, any suitable types of components could be used.

Analysis system 10 has a sample preparation portion 12, other detector portion 23, a mass spectrometer portion 14, a data analysis system 16, and a computer system 18. The sample preparation portion 12 may include a sample introduction unit 20, of the type that introduces a sample containing proteins, peptides, or small molecule drug of interest to system 10, such as LCQ Deca XP Max, manufactured by Thermo Fisher Scientific Corporation of Waltham, MA, USA. The sample preparation portion 12 may also include an analyte separation unit 22, which is used to perform a preliminary separation of analytes, such as the proteins to be analyzed by system 10. Analyte separation unit 22 may be any one of a chromatography column, an electrophoresis separation unit, such as a gel-based separation unit manufactured by Bio-Rad Laboratories, Inc. of Hercules, CA, or other separation apparatus such as ion mobility or pyrolysis etc., as is well known in the art. In electrophoresis, a voltage is applied to the unit to cause the proteins to be separated as a function of one or more variables, such as migration speed through a capillary tube, isoelectric focusing point (Hannesh, S. M., Electrophoresis 21, 1202-1209 (2000), or by mass (one dimensional separation)) or by more than one of these variables such as by isoelectric focusing and by mass. An example of the latter is known as two-dimensional electrophoresis.

The mass spectrometer portion 14 may be a conventional mass spectrometer and may be any one available, but is preferably one of TOF, quadrupole MS, ion trap MS, qTOF, TOF/TOF, or FTMS. If it has an electrospray ionization (ESI) ion source, such ion source may also provide for sample input to the mass spectrometer portion 14. In general, mass spectrometer portion 14 may include an ion source 24, a mass analyzer 26 for separating ions generated by ion source 24 by mass to charge ratio, an ion detector portion 28 for detecting the ions from mass analyzer 26, and a vacuum system 30 for maintaining a sufficient vacuum for mass spectrometer portion 14 to operate most effectively. If mass spectrometer portion 14 is an ion mobility spectrometer, generally no vacuum system is needed and the data generated are typically called a plasmagram instead of a mass spectrum.

In parallel to the mass spectrometer portion 14, there may be another detector portion 23, where a portion of the flow is diverted to for nearly parallel detection of the sample in a split flow arrangement. This other detector portion 23 may be a single channel UV detector, a multi-channel UV spectrometer, or Reflective Index (RI) detector, light scattering detector, radioactivity monitor (RAM), flame ionization detector (FID) etc. RAM is most widely used in drug metabolism research for 14C-labeled experiments where the various metabolites can be traced in near real time and correlated to the mass spectral scans.

The data analysis system 16 includes a data acquisition portion 32, which may include one or a series of analog to digital converters (not shown) for converting signals from ion detector portion 28 into digital data. This digital data is provided to a real time data processing portion 34, which processes the digital data through operations such as summing and/or averaging. A post processing portion 36 may be used to do additional processing of the data from real time data processing portion 34, including library searches, data storage and data reporting.

Computer system 18 provides control of sample preparation portion 12, mass spectrometer portion 14, other detector portion 23, and data analysis system 16, in the manner described below. Computer system 18 may have a conventional computer monitor or touch display 40 (or keyboard) to allow for the entry of data on appropriate screen displays, and for the display of the results of the analyses performed. Computer system 18 may be based on any appropriate personal computer, operating for example with a Windows® or UNIX® operating system, or any other appropriate operating system. Computer system 18 will typically have a hard drive 42 or other type of data storage medium, on which the operating system and the program for performing the data analysis described below, is stored. A removable data storage device 44 for accepting a CD, floppy disk, memory stick or other data storage medium is used to load the program on to computer system 18. The program for controlling sample preparation portion 12 and mass spectrometer portion 14 will typically be downloaded as firmware for these portions of system 10. Data analysis system 16 may be a program written to implement the processing steps discussed below, in any of several programming languages such as C++, JAVA or Visual Basic.

It should be noted that for a more general separation with spectral detection system that this disclosure is applicable to, the ion source portion 24 may be replaced by a power source including a light source for optical detection systems or an X-Ray energy source for X-Ray systems. MS analyzer portion 26 may be replaced by a dispersive apparatus such as grating for optical systems with or without fluorescence option, and the ion detector portion 28 may be replaced with the appropriate corresponding light or energy detectors.

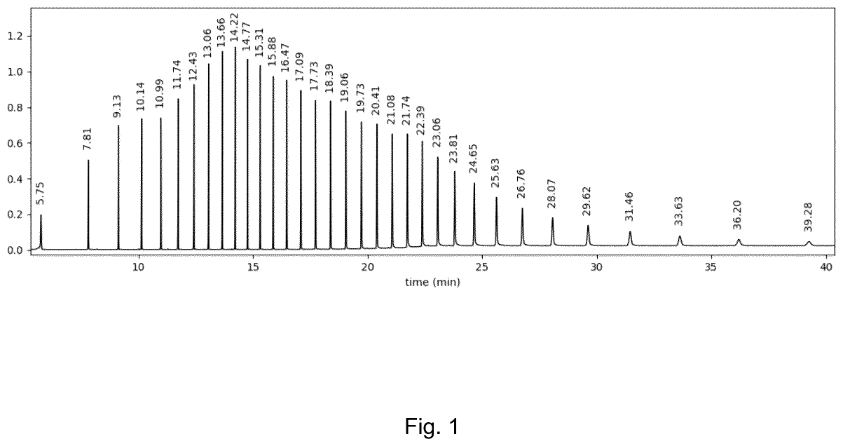

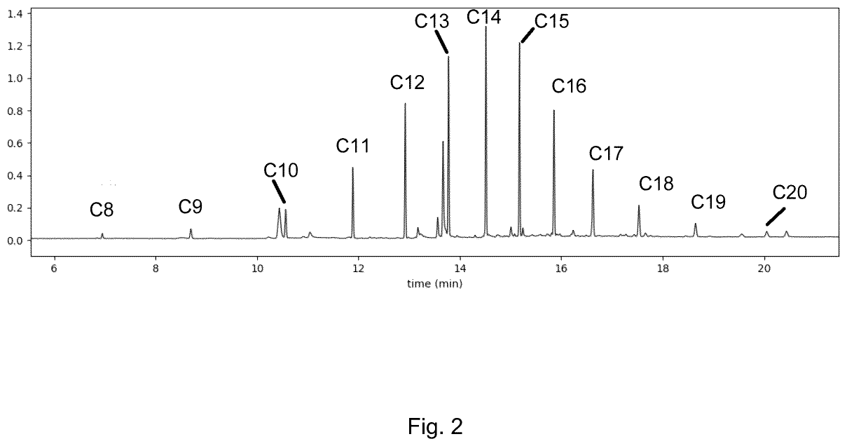

In the preferred embodiment, a sample is acquired through the chromatography/mass spectrometry system described in FIG. 4 with mass spectral data continuously acquired throughout the run, resulting in a data run such as the one shown in FIG. 1 or FIG. 2, which is an example GC/MS run containing many chromatographic peaks including n-alkane calibration standards with (FIG. 2) or without obvious interfering peaks (FIG. 1).

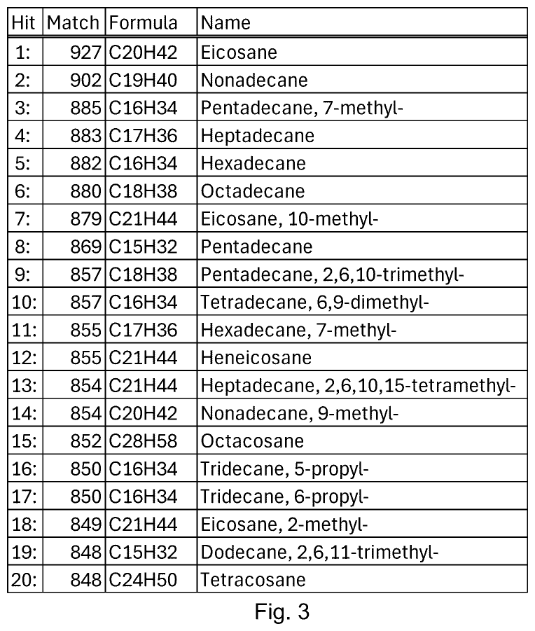

Referring to FIG. 2 and particularly FIG. 3, while the n-alkane may not be correctly identified from spectral search, the best matches will typically be a compound with an n-alkane formula and almost all matches will be for saturated alkanes of the correct empirical formula type C(n)H(2n+2) (FIG. 3). In other words, while heavier n-alkanes are not uniquely or correctly identified, they are identified as being in the n-alkane class or “family” of compounds. This helps us identify the compounds that are in the family of n-alkanes, though not necessarily a specific n-alkane desired.

By using both the relative retention time of the n-alkanes and the library search results together, this disclosure aims to identify the n-alkanes correctly and automatically from a calibration run even in the presence of interfering peaks. This can be accomplished in a number of ways, with the key being to combine multiple pieces information to get at the correct calibration using the correctly identified n-alkane peaks.

A generalized solution to automatically assigning the correct n-alkane RI standards in a calibration run is to use the identification power of mass spectrometry combined with the knowledge or estimation of the typical elution spacing between consecutive or successive n-alkane peaks. As noted previously, heavier n-alkanes are difficult to identify with just MS spectral library search. What typically happens is the heavier n-alkanes are mis-identified as the wrong n-alkane. However, they are still usually identified as an n-alkane, as opposed to the lighter n-alkanes which are correctly and uniquely identified using spectral library search. This allows us to locate the initial lighter n-alkanes and then, using the relative RT spacing between them, we can “bootstrap” and estimate RT spacing on the heavier n-alkanes to enable us to uniquely identify them. This, in turn, allows us to locate the retention time of the later n-alkane peaks and ignore the interfering peaks, thus simplifying the calibration process and enabling it to be easily automated.

There are a number of ways one can estimate the RT of the later n-alkane peaks based on the RT of the lighter alkane peaks, some which we will describe herein. For those skilled in the art, there are various alternative ways to accomplish the same or similar objectives.

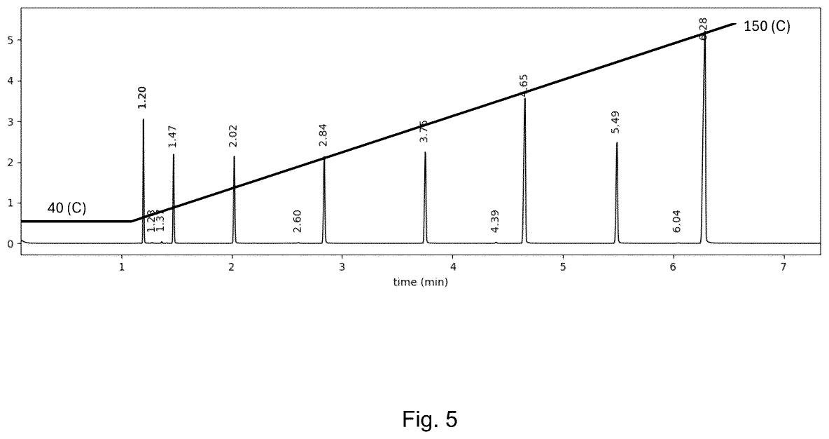

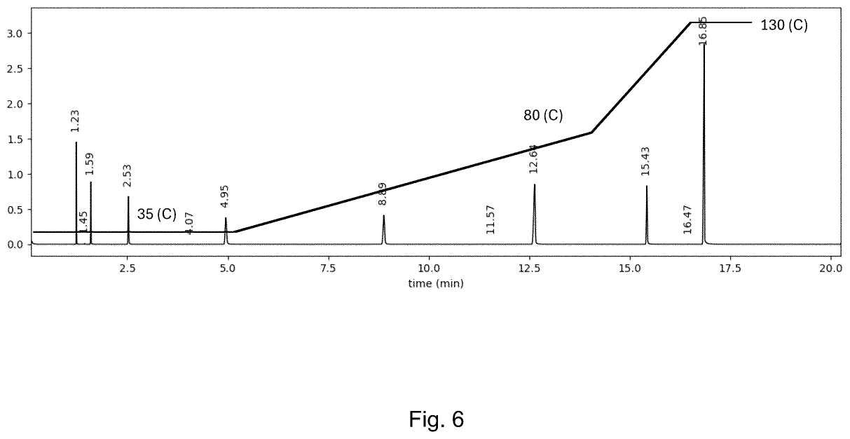

If one examines a typical n-alkane elution pattern such as the one exhibited in FIG. 1, it will show the alkane spacing starting out wide, becoming narrow, and then becoming wider towards the end. These elution patterns are dictated primarily by the GC oven temperature program used over the GC run, as illustrated in FIG. 5 and FIG. 6. Some of the ways to predict the location of the next alkane can be accomplished without knowing the temperature program, or by using more sophisticated techniques that do incorporate the temperature program. Thus, the steps in the first embodiment may include the following:

A). One approach is to estimate the elution time of the next alkane peak by using the three previous known retention times of the n-alkane ladder. One can think of the delta gap between the two previous known n-alkanes peaks as the “velocity” of the elution pattern at that RT. But one also can see that the pattern can smoothly change to either a narrower or wider spacing, which can be considered as the “acceleration” of the elution pattern (either negative or positive, i.e., smaller or larger spacing of the peak elution pattern). The acceleration can be calculated by looking at the second derivative, or the delta-delta of the three previous peaks. The velocity and acceleration can be utilized to predict and locate the next unknown n-alkane peak and therefore avoid peaks that fall outside of this estimated position within a given RT error tolerance window. This error tolerance can be initially computed as the standard deviation of the two delta gaps from the first three alkanes in RT, which should be easily identifiable by spectral search and refined as the difference between the predicted and the actually located alkane RT once more alkanes are found and confirmed. If there are more than a single peak found within the RT tolerance window, one could use spectral library search to locate the next n-alkane, which as discussed, may not be identified as the correct n-alkane, but in the n-alkane family with the correct empirical formula, from which one can assign the n value to be the same as that in the next expected n-alkane in the given series.

B). In the event where one does not have a sequential n-alkane ladder, or have some n-alkane peaks masked from identification due to co-elution with interfering peaks, one could treat the n value as an unknown to be determined from the RT-RI calibration curve (as disclosed in the cross referenced application, U.S. provisional patent application Ser. No. 63/305,969, filed on Feb. 2, 2022 and as International Patent Application PCT/US2023/012187 published as WO 2023/150208) where the correct n value (when included as an additional calibration standard) would provide the best possible fit between the RT and RI with the smallest fitting residual error, in a linear or nonlinear regression process well known in the art.

C). Repeat above steps A). and B). until all expected n-alkanes have been accounted for or the entire chromatogram RT has been covered.

For step A) above, other models of predicting the next n-alkane for the calibration run can also be considered, e.g., modeling techniques that utilize knowledge of the GC instrument temperature programming profile and possibly other measured instrument characterizations such as the “hold up” volume. According to IUPAC, the definition of hold up volume is the volume of the mobile phase (or the corresponding time) required to elute a component the concentration of which in the stationary phase is negligible compared to that in the mobile phase. In other words, this component is not retained at all by the stationary phase. Thus, the hold-up volume (time) is equal to the retention volume (time) of an unretained compound. The hold-up volume (time) includes any volumes contributed by the sample injector, the detector, and connectors. The estimation is again based on using information gained from the early, easily identified n-alkanes to project the location of the later n-alkanes. One such model is that proposed by Bosewell et al. (Boswell P G, Carr P W, Cohen J D, Hegeman A D), Easy and accurate calculation of programmed temperature gas chromatographic retention times by back-calculation of temperature and hold-up time profiles. J Chromatogr A. 2012 Nov. 9;1263:179-88. doi; 10.1016/j.chroma.2012.09.048. Epub 2012 Sep. 23. PMID: 23040964; PMCID: PMC3478941.). In this model, the known thermodynamic properties of compounds (n-alkanes in our case) including DH, DS, and DCp, the temperature program profile, and the calculated hold up volume are used to accurately predict the RT across different GC systems and methods. While it is designed to be a more accurate predictor of target test compound's retention time, one can use the same method in this case to accurately predict the RT of the later alkanes knowing the RT of the earlier alkanes. The known temperature programming profile, along with an estimate of the instrument hold up volume, again provided by the earlier, easily identified alkanes, allows one to more accurately predict the RT of the later n-alkane peaks and identify them uniquely in the presence of interfering peaks. This can be done based solely on the RT, or by combining it with information from the library search.

For step B). above, instead of estimating one higher n-alkane at a time, one could estimate multiple higher alkanes at the same time in an overall nonlinear iterative process by treating more than one n-alkanes as an unknown to be estimated for their correct carbon numbers. In fact, one could treat all the remaining higher n-alkanes as unknowns for which the correct integer carbon numbers need to be determined in order to have a smooth RT-RI calibration curve with the smallest fitting residual, in a linear or nonlinear regression process well known in the art.

More broadly, step A). could be constructed as an initial RT-RI calibration model involving as few as only two RI calibration standards (two n-alkanes, for example, with one at the start of the RT range and highly confidently located and the other at or near the end of the RT range and not so confidently identified). This initial model can be used to locate the RT of other calibration standards which could then be included as additional standards into a more refined RT-RI calibration model, with fitting residual from either linear or nonlinear regression calculated as an indication for the correct location of the desired standards, the location of which could then be iteratively refined by re-assigning or re-locating existing or additional standards. This process can be repeated until convergence (i.e., no further improvement can be made) or when the regression residual falls below a certain threshold (e.g., 20 i.u. or index unit, a level of error typically seen in retention index database such as the NIST MS spectral library).

It is also be pointed out that while n-alkanes are the most common RI standard, this does not exclude the use of this method on compounds which are not n-alkanes, or mixtures of n-alkanes and other compounds, provided that the RI of the non-n-alkane compounds are known. When applied to a concentration standard mixture sample such as pesticide standards, which typically contain up to 100 pesticide standards spanning a wide RT range at some low concentration levels such as 10 ppb, one can perform extracted ion chromatogram (XIC). This is done by picking out a characteristic ion or ions (m/z value) for each pesticide standard compound and locating a unique respective RT (unlike n-alkanes where the XIC from many n-alkanes may be very similar or even identical). One can then plot out the RI vs RT followed by a linear or nonlinear regression process to build an initial RI calibration model, which can then be refined by eliminating the standard compounds with high fitting errors or by re-assigning the RT to a different peak in its XIC containing more than one peak. The use of XIC is advantageous due to the low concentration levels involved which may not result in a significant peak to be detected from the TIC (total ion chromatogram) and/or a good enough spectral library search for it to be confidently included as a calibration standard, through the RI self-calibration process disclosed in the cross-referenced application (United States provisional patent application Ser. No. 63/305,969, filed on Feb. 2, 2022 and as International Patent Application PCT/US2023/012187 published as WO 2023/150208).

It should be emphasized, that there are a variety of ways to predict and locate the heavier alkane peaks in a run, but they always incorporate knowledge of early eluting n-alkanes and can leverage other known factors of the run including the temperature programming profile and other instrument characteristics. These methods may also be combined with a library search, which can confirm that the peak is indeed in the n-alkane family. Examples of other approaches may include AI models, different types of fitting, and time series algorithms such as a Kalman filter (https://en.wikipedia.org/wiki/Kalman_filter).

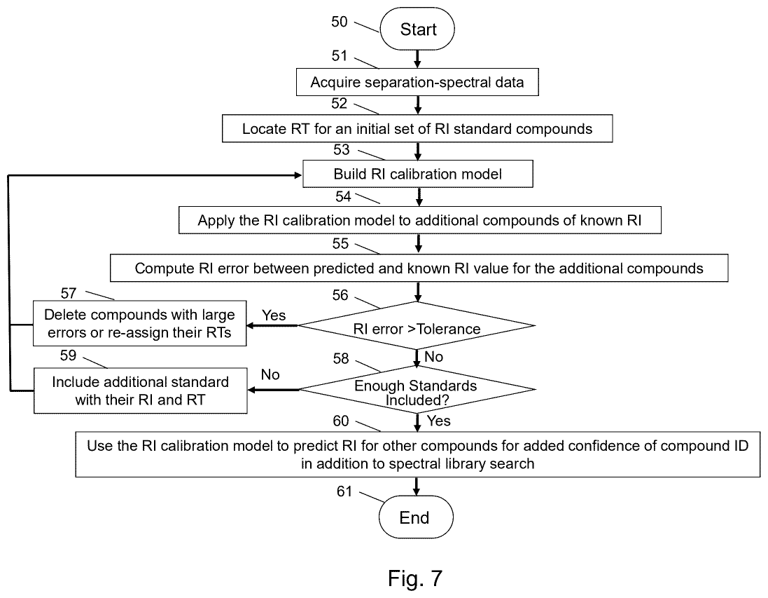

FIG. 7 shows the above steps in a flow chart of the first embodiment described herein where at 51, spectral data is acquired during the analyte separation process so that separated peaks can be detected. At 52 a RT time window is located corresponding to a standard compound of known retention index to be included in the initial set of RI standards. This can be accomplished by either spectral library search or XIC of characteristic ion or both. At 53, an initial RI calibration model is built to relate RT to RI using any of the calibration models or functions. At 54, the RI calibration model is applied to additional compounds of known RI values for consideration as possible additional RI standards to be included in a more inclusive RI calibration model. At 55, an RI error is computed between the predicted RI value from the calibration model and the known RI value for a possible standard compound. At 56, compounds with RI errors larger than a preset tolerance or threshold are identified. At 57, these compounds with large RI errors are either removed from the set of standard compounds used for the calibration model or re-assigned with different RTs before the RI calibration model is rebuilt at 53, until the majority (e.g., 95%) of all the compounds in the calibration set have their RI errors below a preset tolerance. At 58, if more RI calibration standards need to be considered, they will be included at 59 to augment the calibration set used to rebuild the RI calibration model at 53, until enough standards have been considered and included. At 60, the RI from a test compound is predicted using the RI calibration model based on its elution RT and used as additional identification metric to increase the compound ID confidence from spectral library search.

Although the description above contains many specifics, these should not be construed as limiting the scope of the invention but as merely providing illustrations of some feasible embodiments. For example, RT-RI calibration can be built from a pure standard run containing the known standards of n-alkanes, from a test sample itself spiked with known standards, or from a sample run containing only test compounds without any standards in a self-calibration process as outlined in a cross-referenced application (U.S. provisional patent application Ser. No. 63/305,969, filed on Feb. 2, 2022 and as International Patent Application PCT/US2023/012187 published as WO 2023/150208). One can also start with the previous RT-RI calibration run, where appropriate due to the high reproducibility of a given GC/MS system and apply that to a new calibration run as the starting point for RT prediction in step A). This prediction or modeling could then be replaced, enhanced, or refined by adding additionally identified highly probable compounds from a future run into the subset created from a prior run, to dynamically enhance and improve the RT-RI model over all multiple runs or over time. Although the RI calibration model has been discussed above using either a linear or nonlinear regression process well known in the art, the model can also be structured as a linear or nonlinear interpolation or some combination of functional and graphical model such as a nearest neighbor clustering interpolation (https://en.wikipedia.org/wiki/Nearest-neighbor_interpolation). Other mathematical, statistical, numerical, and graphical models may be used as well, including polynomials, splines, probabilistic functions such as logit functions, wavelets such as Poisson wavelet, or a proper combination of these either taken across the entire RT range or for a given RT range. Instead of a certain mathematical or statistical model described above, certain graphical or even purely numerical models (e.g., nearest neighbor clustering, replacement, or averaging etc.) could be used instead. One can also iterate or perform an exhaustive search among these possible models to come up with the best possible model, which fits the existing data set well in the least squares or other sense, but without overfitting them, i.e., with some residual error on the order of the known retention index measurement error bound of 5-20 iu. When it is possible to linearize, e.g., in the case of polynomials, multiple linear regression (MLR) may be readily applied, using the methodology referenced in U.S. Pat. Nos. 7,577,538 and 6,983,213.

Thus, the scope of the disclosure should be determined by the appended claims and their legal equivalents, rather than by the examples given. Although the present disclosure has been described with reference to the embodiments described, it is understood that it can be embodied in many alternate forms of embodiments. In addition, any suitable size, shape or type of elements or materials could be used. Accordingly, the present description is intended to embrace all such alternatives, modifications and variances which fall within the scope of the appended claims.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method for the analysis of compounds of interest through separation over time when using a spectral detection system, comprising the steps of
a. acquiring spectral data for a sample containing at least two standard compounds of known retention indices;
b. using the spectral data to select relevant retention time windows corresponding to the at least two standard compounds of known retention indices;
c. building an initial retention index calibration model using the at least two standard compounds of known retention indices; and
d. refining the initial retention index calibration model by one of adding additional or removing existing standard compounds of known retention indices from the calibration model.

2. The method of claim 1, where the separation used is one of gas chromatography (GC), liquid chromatography (LC), supercritical fluid chromatography, ion chromatography (IC), capillary electrophoresis (CE), gel electrophoresis, ion mobility, and pyrolysis.

3. The method of claim 1, where the spectral detection system is one of a sector mass spectrometer, quadrupole mass spectrometer, Time-of-Flight (TOF) mass spectrometer, Orbitrap mass spectrometer, Fourier-transform ion cyclotron resonance (FT ICR) mass spectrometer, optical spectrophotometer including Ultraviolet (UV), Visible (Vis), Near-Infrared (NIR), Infrared, Raman, fluorescence, X-Ray, and X-Ray fluorescence.

4. The method of claim 1, where the retention time includes one of chromatographic retention time, elution time, drift time, and separation time.

5. The method of claim 1, where the calibration model is one of a polynomial of a given order, a spline function of a given order, a probabilistic function of a given form, a wavelet of certain form, a graphical model, a numerical model involving one of speed and acceleration, a time series model including Kalman filter, a thermodynamic model including at least one of hold-up volume and one of three thermodynamic constants deltaH, deltaS, and deltaCp (DH, DS, and DCp), a mathematical model involving temperature programming information, and a combination of these segmented over a given retention time window.

6. The method of claim 1, where the spectral data is used to search an existing MS spectral library to select the relevant retention time window corresponding to a standard compound of known retention index.

7. The method of claim 1, where the spectral data is processed into extracted ion chromatogram (XIC) to select the relevant retention time window corresponding to a standard compound of known retention index.

8. The method of claim 1, where the refining step is repeated iteratively by adding an additional standard compound of known retention index not already included in the calibration model.

9. The method of claim 1, where the refining step is repeated iteratively by removing a standard compound of known retention index already included in the calibration model.

10. The method of claim 1, where the refining step is repeated iteratively by assigning a different retention time to a standard compound of known retention index already included in the calibration model.

11. The method of claim 1, where the iteration terminates when the difference between the predicted retention index and the known retention index is one of minimized or reduced to below a given threshold and a sufficient number of standard compounds have been included in the calibration model.

12. The method of claim 1, where the calibration model is used to predict the retention index of an unknown compound from its measured retention time.

13. The method of claim 12, where both the predicted retention index and the spectral library search are utilized together to indicate the likelihood of a positive compound identification.

14. A spectral detection system including a mass spectrometer operating in accordance with the method of claim 1.

15. For use with a computer associated with a spectral detection system including a mass spectrometer, a computer readable medium having computer readable program instructions readable by the computer for causing the spectral detection system to operate in accordance with the method of claim 1.
